(19) United States
(12) Patent Application Publication
(10) Pub. No.: US 2020/0146442 A1
(43) Pub. Date: May 14, 2020

(54) Optical Workplace Status Display System

(71) Applicant: Marco Rutzke, Hohenstein-Ernstthal (DE)

(72) Inventor: Marco Rutzke, Hohenstein-Ernstthal (DE)

(21) Appl. No.: 16/618,267

(22) PCT Filed: May 29, 2018
(86) PCT No.: PCT/DE2018/100522

§ 371 Date: Nov. 29, 2019

(30) Foreign Application Priority Data
May 29, 2017 (DE) 10 2017 111 679.6

(51) Int. Cl. A47B 21/04; A47B 83/00; G08B 5/36

(52) U.S. Cl. CPC A47B 21/04; A47B 83/001; A47B 2083/006; A47B 2200/0073; G08B 5/36

(57) ABSTRACT

A multifunctional, highly visible and perceptible optical workplace status display system. In particular, the optical workstation status display system should make the occupancy or availability of the office workstation, the usage status of office communication devices and/or the status of the employee optically visible. The workstation status display system should be adaptable to different office workstations and individual requirements.

### CROSS REFERENCE TO RELATED APPLICATIONS

This application is the U.S. national stage of International Application No. PCT/DE2018/100522, filed on 2018 May 29. The international application claims the priority of DE 102017111679.6 filed on 2017 May 29; all applications are incorporated by reference herein in their entirety.

### BACKGROUND

The invention concerns an optical workplace status display system. The optical workstation status display system comprises an illuminated display and/or a screen as part of an office furniture or for attachment to or integration in an office furniture, an interface to at least one office communication device, at least one application and/or a manual or sensor-controlled switching unit. In addition to desks or work tables, office pieces of furniture can also include cabinets, shelves, sideboards or soundproof walls.

A clearly visible display of the status information regarding the use or availability of the office workstation is realized by means of the illuminated display and/or the screen which is attached to or integrated into an office piece of furniture. The interfaces connected with the display to the relevant office communication devices and applications appropriately available at the workplace enable the recording of the respective status with regard to the use or availability or exposure of the corresponding office communication devices and the employees and can thus be displayed.

Status display systems are known in different designs. Many devices are equipped with a status display. Washing machines or dishwashers, for example, display the program sequence.

For production lines, displays are provided in the room, indicating the status, for example, the standard operation or malfunctions, as well as warnings in the event of deviations from the standard operation. In motor vehicles there are displays that show the status of the individual assemblies, such as lighting, rear window and seat heating or temperatures. Display systems that indicate the status of the individual units are installed in the control rooms of power plants.

Status displays for network routers and computers are also known. Telephone displays that indicate missed calls and messages on the answering machine, for example. are known. Printers, for example, also show their status on a display.

### SUMMARY

The invention aims at providing a multifunctional, highly visible and perceptible optical workplace status display system. In particular, the optical workstation status display system should make the occupancy or availability of the office workstation, the usage status of office communication devices and/or the status of the employee optically visible. The workstation status display system should be adaptable to different office workstations and individual requirements.

### DETAILED DESCRIPTION

The invention aims at providing a multifunctional, highly visible and perceptible optical workplace status display system. In particular, the optical workstation status display system should make the occupancy or availability of the office workstation, the usage status of office communication devices, the usage status of applications and/or the status of the employee optically visible. The workstation status display system should be adaptable to different office workstations and individual requirements.

According to the invention, the task is solved by a workplace status display system with the characteristics of the main claim. The optical workstation status display system comprises at least one illuminated display and/or a screen for mounting or as part of an office furniture. One or more illuminated displays and/or screens are arranged on or integrated or in an office furniture, the illuminated displays and/or screens having at least one interface to at least one office communication device, room equipment, application and/or at least one manually or sensor-controlled switching unit and/or to at least one sensor in order to indicate the status with respect to an office workstation and/or to office communication devices, applications, ambient conditions and/or to employees. The type of interface depends on the respective circumstances and on the hardware and software used for the office communication devices, room equipment or applications or for the switching unit or sensors used. The interface can also be a radio interface.

Office communication devices and room equipment also represent an infrastructure.

It is advisable to have your own or a separate power supply. However, the necessary power supply can also be implemented via the interface or the office communication devices or the room equipment. This depends on the respective ambient conditions and the relevant office communication devices available in each case or on the respective room equipment and its specification.

The optical workplace status display system enables good visibility of the status information regarding the use or availability of the office workstation or employee or the environmental conditions of the room or workstation and of vital parameters, in particular reference to movement inactivities, by means of the at least one illuminated display arranged on an office furniture. In addition, independent status information, such as the use or availability of the office workstation or employees, rooms or the ambient conditions of the room or workstation, such as the ambient noise or air quality or the need for light and vital parameters, in particular with regard to movement activities and, independently, can be displayed on one or more screens, in each case also combined with recommendations, and, if the screen is appropriately designed, for example as a touch-sensitive screen or a screen controllable by gestures, also allow to make entries for the adaptation or operation of status information, office communication devices, room equipment, ambient conditions and/or applications.

The attachment of the illuminated display and/or the screen to office furniture includes the integration of the illuminated display and/or the screen into the office furniture. The status with regard to the use, the availability or the exposure of the corresponding office communication devices and/or room equipment and/or ambient conditions and/or vital parameters is clearly and visibly indicated by the interfaces connected to the light display and/or the screen to the relevant office communication devices and/or room equipment and/or to the vital parameters present at the office workstation, or unfavorable ambient conditions or excessively long movement activities, for example, are pointed out. A manual switching unit enables the employee to set an individual status for display. The switching unit can be designed using a touch-sensitive or gesture-controlled screen and suitable peripherals, for example. Similarly, there may also be switches that are arranged individually or in connection with the screen.

Furthermore, the switching unit can be part of an office communication device, which simplifies the structure of the workplace status display system and also reduces the number of components. For example, the sensor-controlled switching unit is part of a workstation computer to which suitable, for example USB interfaces or radio interfaces such as WLAN, Bluetooth or NFC sensors can be connected.

A status can be, for example, a reservation of the workstation in the case of a current absence or a request not to be disturbed or an availability or a call status, for example for phoning. It is also used to check whether certain devices belonging to a room equipment are inadvertently active or are reserved or claimed or forgotten to be deactivated, switched off or released by an employee, whether these actions are authorized or accidental. Furthermore, indications can be given that an exercise break or a change of body position is appropriate. In addition to the office communication devices that are part of the workstation, the lighting belonging to the workstation or work group can also be adapted to requirements.

The illuminated display is preferably recessed in the outer edge or in the surface, for example near the outer edge of the table top of the office furniture. The screen would preferably be embedded in a surface such as the surface of the table top, for example. However, it is also possible to glue or screw it on if required and allows retrofitting, for example. The connections to office communication devices and/or to room equipment can be performed easily, for example via the standardized USB interface, via the network or via known radio interfaces.

The sensor-controlled switching unit enables the display of information resulting from the sensory data acquisition of the use or presence of the/a user. This can refer, for example, to the assignment of a chair or the proximity to a computer mouse or keyboard or tabletop or the approach of a mobile terminal device, such as a smart phone or a tablet PC. For this purpose, different sensors are connected to the sensor-controlled switching unit, which are suitable for detecting functions of room equipment and/or ambient conditions and/or vital parameters.

The optical workstation status display system prevents disturbance of office work in particular. By displaying the usage status, the workstation status display system can also help to easily monitor existing workplace capacities, for example in open-plan offices, call centers or libraries, and to use and occupy them in a flexible and effective manner. The different statuses can thus be displayed with the workstation status display system. Depending on the version, these different states can be regularly repeated one after the other in a changing sequence or displayed parallel to one another. This creates a multifunctional workstation status display system which serves to display different states. A screen can also be used to display information or notes on the above-mentioned displayable states or to make adjustments to the status, office communication devices, room fittings and/or applications.

Room equipment includes, for example, lighting equipment, acoustic equipment, heating equipment, air-conditioning equipment, ventilation equipment and locking equipment as well as room sections such as meeting areas, which are used, changed or required depending on the employees and their area of responsibility and must also be taken into account by others in this context.

Applications include, for example, telephony applications with computer-controlled call distribution or chat applications or other user-related or employee-related applications to which employees or users log on and or from which they log off. Applications include, for example, booking programs for rooms.

According to an advantageous design of the invention, the illuminated display is arranged or integrated in vertical sections of a table structure, in or on at least one outer edge of a table top, in or on the surface of a table top or in an office furniture wall. The surface of the table top comprises not only the surface pointing upwards, but also the surface pointing downwards. The arrangement of the illuminated display on the downward facing surface as the underside achieves indirect illumination of the foot area or the area under the table top, which is also conducive to the room ambiance in addition to the workplace status display. The illuminated display arranged or integrated on the outer edge(s) of the table top can be achieved, for example, as an all-round workplace status display, which can thus be recognized from a wide variety of perspectives. In addition, the equipped work tables or desks can be arranged in any order, as an area of the surrounding workstation status display is always visible. For this purpose, for example, light-conducting bodies with one or more distributed light sources can be provided. The distributed light sources can be used to assign different states of the workstation status display to different areas.

The vertical sections of a table structure are, for example, the table legs, wall-like cladding components or other structural elements with vertical extension. The workstation status display can also be arranged on these. In this case, it can be arranged vertically or horizontally, depending on the specific circumstances.

The term office furniture wall refers in particular to cabinet and shelf components as well as partition walls or other wall-like cladding components.

It is clearly visible thanks to the corresponding integration of the illuminated display. The integration of the illuminated display enables an attractive visual design of the office furniture. The integration prevents interference from illuminated displays protruding from the surface. Here too, where appropriate, an all-round workstation status display can be provided.

In accordance with an advantageous further development of the invention, the illuminated display is circular, band-shaped, segmented and/or individually controllable as a running light. For example, individual illuminated displays can be individually controlled to create a running light. On the other hand, it is also intended that the illuminated display is designed as a running light and can be controlled accordingly. The circular or band-shaped design of the illuminated displays, for example, makes it easier to see from different angles. Running lights or flashing lights, if necessary with different colors, can also be realized. The band-like arrangement of the illuminated displays also allows for different design options. A continuous alternating and cyclically repeating display is thus possible. Alternatively, it is possible with segmented illuminated displays to display different states simultaneously and in parallel. In this way, these status displays can be constantly recognizable and a change of the displays, and thus an overlooking or longer waiting until the next, repeated displays, are avoided. However, a continuously changing and cyclically repeating display is also possible with the segmented illuminated display.

To enable more complex status displays, at least one multicolor LED is provided in accordance with the design of the invention. This allows different colors to visualize different uses and employees according to the status to be displayed.

Furthermore, the workstation status display system includes a screen, which is preferably recessed into the table top or a suitable surface of the respective office furniture or arranged on it in a simple design. In or on the surface of a table top, at least one screen can be arranged or integrated on at least one outer edge of the table top. This is also possible in or on vertically aligned sections of a table structure and/or in an office furniture wall. However, the screen may alternatively or additionally be the screen on a workstation computer or mobile terminal device, including a portable computer or smartphone, enabling efficient use of existing office communication devices with a suitable screen.

The screen is advantageously touch-sensitive and/or can be controlled or operated by gestures and/or comprises an input unit for adjusting the status in relation to the office workstation and/or to the office communication devices, applications, ambient conditions and/or to the employee. Since the screen includes a gesture control, making changes to the status or for further operation is easy.

In addition to the presentation of the corresponding status displays, changes in status, settings or other actions can also be made, which, in addition to the adjustment or confirmation of the respective status, for example, also allow to make adjustments to ambient conditions such as lighting and air conditioning as well as adjustments to the workstation, such as the table height. The operation or booking of rooms or other corresponding functionalities can also be carried out. Information on vital parameters, in particular reference to motion inactivities, can also be displayed and the employee can be given appropriate information and recommendations on changes that are beneficial to him or her. Information on the quality of the ambient conditions, such as air quality and ambient noise, can also be displayed. In addition, indications, pieces of information or availabilities of office communication devices and rooms as well as their ambient conditions, such as temperature and air quality or usable equipment, can also be displayed on this screen. It is also possible to display indications on the respective energy consumption of the workstation and any potentials for energy savings.

The displays and adjustment options mentioned as examples can be implemented independently and result from the respective requirements.

The sensor-controlled switching unit is advantageously connected to an infrared sensor, a proximity sensor, a motion detector, a noise sensor, an energy consumption sensor, a temperature sensor, a gas sensor, a vital sensor, a gyro sensor and/or a closing contact. The sensors monitor environmental conditions such as temperature, air quality, ambient noise, presence sensors and/or energy consumption as well as vital parameters, for example, to give the user instructions or recommendations to change his behavior or to change the environmental conditions by active action, for example by changing his posture from sitting to standing, by an exercise break or by a targeted room ventilation.

The gyro sensor or several gyro sensors, possibly paired with a closing contact, detect the movements of office chairs or other objects, building equipment or office furnishings, so that for example the rising of an employee and the resulting movement sequence and speed of movement of the chair can point to a distance from the workplace and thus cause the status of the employee to be adjusted to the applications or the office communication devices and to the light display or the screen. Particularly if the employee should fail to actively change his or her status, the status can be changed reactively.

Doors and their opening direction or direction of movement and speed of movement can thus also be detected accordingly.

In addition, the movement speed of office chairs or other objects, building or office equipment can be recorded independently, enabling simple use and condition monitoring, panic detection and also initiation of an alarm trigger.

The gyro sensors and any existing closing contacts are preferably connected to the switching unit via radio interface due to their location, although wired connections to the switching unit are not excluded.

The energy consumption sensors can be used, for example, to record terminal devices that have not been used for a long time and switch them off or put them to standby mode or switch off lighting that is not required. Infrared sensors or motion detectors can detect and thus indicate the presence of persons in rooms that are not visible or only partially visible. With the aid of a closing contact, the occupancy of a chair or the locking of a door can be clearly indicated from the outside. The proximity sensor enables the presence of an employee to be detected directly at the respective workstation.

For example, the presence sensors can be used to determine whether or not an employee has left his or her workplace. In combination with, for example, a schedule, the respective calendar or using the recording of a mobile terminal device outside the respective building, it is possible to draw conclusions based on which the status of the employee and, consequently, the status display can be adjusted accordingly. This can also mean that the workstation with a computer is shut down or put to sleep, for example.

In this way, messages can also be sent to employees who are not present but are currently logged on to the corresponding workstation. The employee can then decide what should happen with the setting of the status display as well as with the workstation and the computer.

The status displays mentioned above can be displayed on a computer screen or on the screen of a mobile terminal device. By operating the computer or mobile terminal device, the settings or other actions can also be carried out as described above. The displays and adjustment options can be implemented independently and result from the respective requirements.

The display and operation on these screens are independent of each other and independent of the illuminated display, so that parallel or separate operation of the respective screens and the illuminated display is possible.

Office communication devices include, for example, telephones, computers, printers, scanners, copiers, fax machines and/or other network devices. Mobile devices such as smartphones or tablet PCs are also included. Accordingly, the user status of the devices and the status of the respective employee can be displayed or the employee can be provided with instructions. In particular, the display prevents interference during telephone calls.

By coupling with network devices that are at least a switch, a router or a server, for example, displays for these devices can also be displayed simultaneously or sequentially as remote displays for other workstations, office communication devices or users. Coupling and networking with other applications, office communication devices or users are thus possible.

This allows you to see which devices or applications are blocked, available or even disturbed by or for other users.

According to a further training of the invention, at least one interface is designed as a programmable control unit. Alternatively, the light indicator, the screen and/or the interface work together with the control unit. The control unit makes it possible to realize complex displays depending on the input signals of the office communication devices or the manual input according to the requirements of the users or on the basis of the sensors through the light display. These displays make it possible to show complex pieces of information in conjunction with several illuminated displays or illuminated displays from several segments and multicolor LEDs.

Preferably, the control units can be programmed according to user requirements, for example by connecting to a computer or server.

According to a further design of the invention, an acoustic output unit and/or a vibration unit is connected to the workstation status display system. The acoustic output unit and/or a vibration unit can, for example, emit or generate a warning tone or a largely silent vibration signal in case of disturbing approach of persons or critical disturbances of the workstation status display system or disturbance of the office communication devices. The acoustic output unit and/or the vibration unit can also be used for an appointment reminder (alarm clock).

The acoustic output unit can also be designed to enable the output of speech signals.

According to the advantageous further training of the invention, a user administration application, an electronic reservation system and/or a recognition unit is connected to the workstation status display system. By connecting to the user management application and the electronic reservation system, the workstation status display system can indicate an existing or imminent reservation of the workstation and the availability of the employee for telephony or chat applications.

The recognition unit enables personal user identification. In addition, the recognition unit can record biometric data or read out codes from a user or company ID card. The knowledge of the users enables for example a billing of workstations in libraries or the creation and monitoring of co-working spaces or also a bidirectional connection to the office communication devices in order to make preferred user presettings there.

### BRIEF DESCRIPTION OF THE DRAWINGS

Advantageous design examples of the invention are explained in detail based on drawings.

The following is shown:

FIG. 1 A view of a table top of a working table or a desk from below with integrated illuminated display of a workstation status display system,

FIG. 2 A view of a table top of a working table or a desk from below with integrated illuminated display and integrated screen of a workstation status display system,

FIG. 3 A side view of a table top of a working table or a desk with integrated illuminated displays of a workstation status display system,

FIG. 4 A schematic representation of a workstation status display system with illuminated displays and interface to a telephone.

### DETAILED DESCRIPTION OF THE PREFERRED EMBODIMENTS

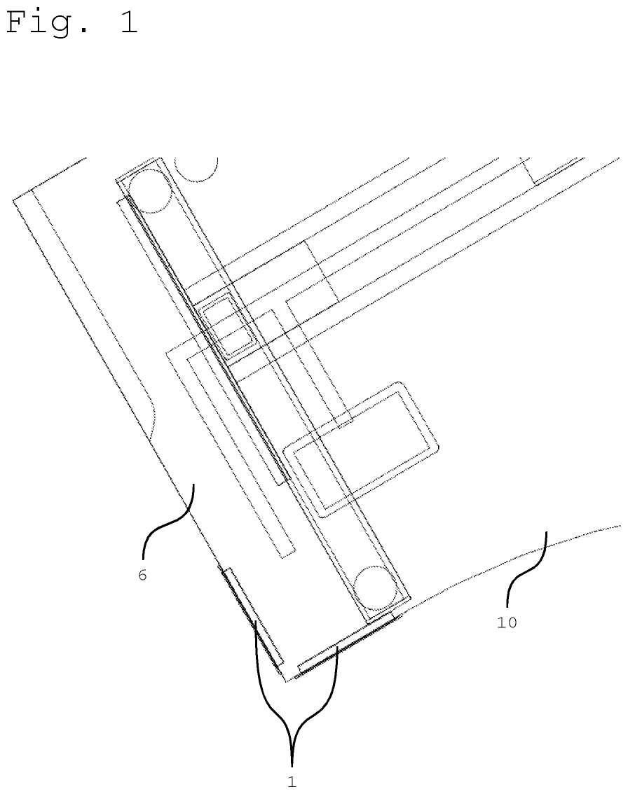

FIG. 1 shows a view of a section of a desk top 6 of a working table or a desk 6 from below with integrated illuminated display 1. The workstation status display system according to the invention comprises at least one LED illuminated display 1. Two illuminated displays 1 are shown here, which are recessed at one corner in the adjacent vertical surfaces of the outer edges, i.e. a vertical section of the desktop 6.

In a specific, not illustrated design example, the illuminated display 1 has an interface 2 to an office communication device 3, to an application and to a sensor-controlled switching unit 4, 5, whereby the at least one illuminated display 1 is designed via multicolor LEDs to indicate the status with regard to an office workstation and/or to office communication devices, applications, ambient conditions and to employees.

In this design example, the office communication device 3 is a workstation computer with screen 9 and a network connection. In addition, a chat application, such as a service hotline on the workstation computer, is available as an application to which the user logs on and off. The chat application communicates via the network connection with a server that is also an office communication device 3. As office communication device 3, a telephone is also connected to a telephone system with a network connection or designed as an IP-phone or similar. This means that the telephone has at least a logical and functional connection to the other office communication devices 3. The telephone can also be a softphone application of the workstation computer or an application of a smartphone with a network connection to at least one of the other office communication devices 3. This means that the telephoning status of the employee or of the workstation is also recorded, since an employee can also make absent calls from the workstation via suitable mobile terminal devices such as smartphones, cordless telephones or headsets. The workstation is therefore empty but not free.

This means that essential workstation functions are initially provided.

In addition to the office communication devices and the chat application, there is also a sensor-controlled switching unit 4, 5, which, in this concrete design example, is connected to the workstation computer via a USB interface. Alternatively, the sensor-controlled switching unit 4, 5 can also be connected to the network. This switching unit 4, 5 is equipped with a temperature sensor, a gas sensor, a noise sensor and a vital sensor. The temperature sensor and the gas sensor monitor the temperature and the room air quality in the event of unfavorable deviations or ambient conditions, either to bring about a change immediately or to give indications for a change. The noise sensor detects ambient noise to alert the concentrated worker that the background noise level is unfavorable and will or can cause distractions.

In this concrete design example, the illuminated display 1 is connected to the workstation computer as office communication device 3 via a USB interface. A corresponding suitable application program on the workstation computer represents via this computer the interface 2 to the other office communication devices 3 and records the respective user status of the application. In addition, the sensor data of the sensory switching unit 4, 5 are recorded and prepared accordingly and made available to the application program as an interface for the light display 1. Depending on the status of the employee's office communication devices 3 and the sensor readings, for example, light display 1 shows a green light for free, a red light for busy, a yellow light for free but absent or a blue light for sensitization to unfavorable environmental conditions. For example, if different statuses occur at the same time, they can also be displayed next to one another in parallel or one after the other.

To support the employee, the respective statuses can also be displayed on screen 9 of the workstation computer. In addition to the display, certain statuses can also be changed, such as logging on to and off applications or on the telephone, switching lights or operating office communication devices 3.

In addition to the ambient conditions, the vital parameters can also be recorded, particularly with regard to a one-sided posture or too prolonged immobility. This can be done via vital sensors which, like the other sensors, are also connected to the switching unit 4, 5 or which are directly connected to the office communication device 3. The vital sensors, for example worn on the body, can also be coupled with a mobile terminal device, for example via Bluetooth, which then transmits corresponding vital parameters to the office communication devices 3 via the network connection, so that these vital parameters can also be displayed on the respective screen 9.

In addition, the office chair is equipped with one or two gyro sensors and a closing contact, which detect the movement of the respective office chair via a radio interface and detect an employee getting up. Based on this and the subsequent movement sequence of the chair, conclusions can be drawn that the employee has left the workplace. If the employee has failed to log off from the applications, the employee's status is adjusted in relation to the applications via the switching unit 4, 5 and the office communication devices 3 and via the interface on the light display.

For example, the illuminated displays 1 are connected wirelessly or via lines and an interface, the hardware and/or software interface is not illustrated connected to various office communication devices and/or sensors in order not to show the status of the office communication devices belonging to the workstation or to show the use of these devices with the light displays 1 as shown.

The openings and cable guides required for the entry of the illuminated displays 1 into the desk panel 6 are realized, for example, by corresponding routings in the downward facing surface 10 or in channels in or on the downward facing surface 10 desk panel 6.

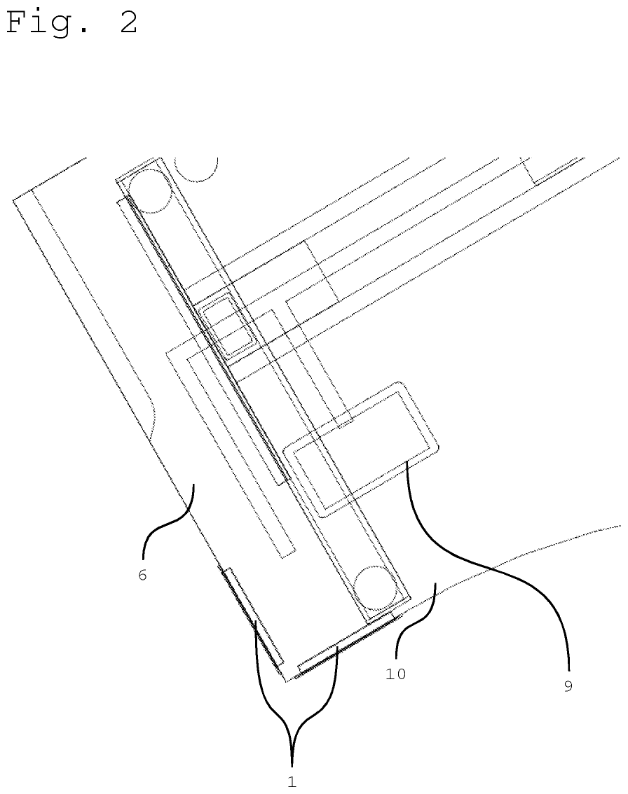

In addition to FIG. 1, in FIG. 2, a screen with gesture control is embedded in the upward pointing surface 10 of the desk top. Corresponding connecting cables are laid in or under the desk top 6 via milled cable ducts. In a simpler version, the screen 6 is touch-sensitive.

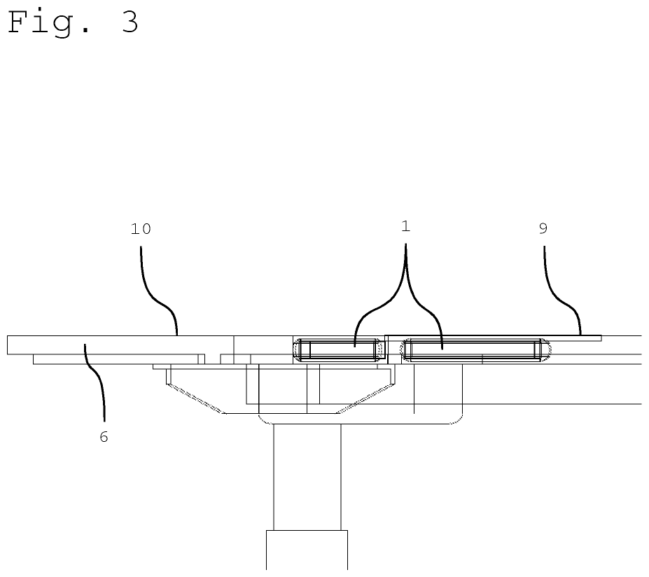

FIG. 3 shows the side view of a desk top 6 known from FIG. 1 with integrated illuminated displays 1 of the workstation status display system.

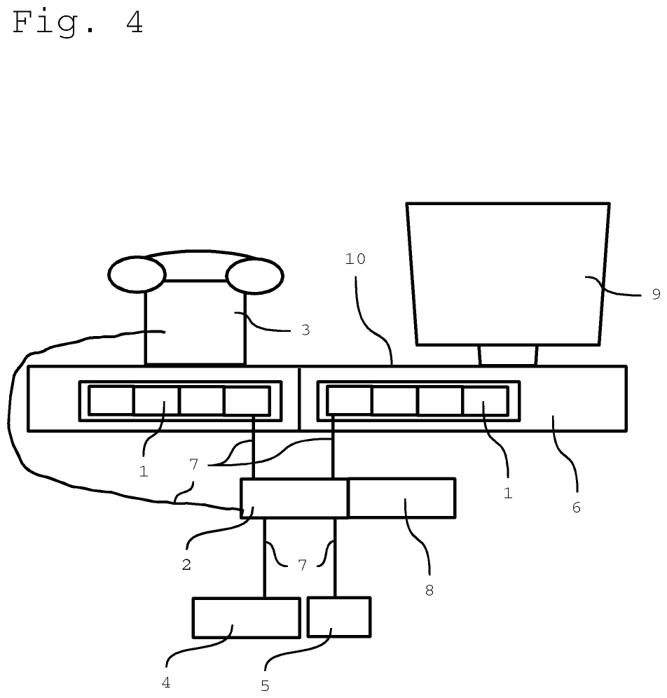

FIG. 4 shows a further design example of a system for workstation status display with two LED displays 1 consisting of several segments on a desktop 6, an interface 2 to a telephone 3 as well as a manual switching unit 4 and a sensory switching unit 5. The phone 3 is shown here as an example for an office communication device 3. The interface 2 is connected via connection lines 7 to the illuminated displays 1 and a power supply unit 8, for example a power adapter 8.

The interface 2 to telephone 3 is also the interface 2 for signals of the manual switching unit 4 and the sensory switching unit 5 and connected to them via connection lines 7. The connecting cables 7 are preferably connected by standardized plug contacts to the interface 2, the office communication devices 3 and the switching units 4, 5. Alternatively, a wireless data transmission can also be implemented.

Interface 2 is designed here as control unit 2 for controlling the illuminated display 1. The control unit 2 is able to process the individual incoming signals of the individual office communication devices 3 and/or sensory switching units 4, 5 and to control the illuminated display 1 sensibly.

The control unit 2 is connected directly to the workstation computer as office communication device 3.

Alternatively, the control unit 2 can be connected to the network. On the one hand, all the necessary information and statuses can be collected on the workstation computer using suitable software and transmitted to the control unit 2 or the control unit 2 interrogates the other office communication devices 3 with or without applications and the switching unit 4, 5 via the network. The control unit 2 then controls the illuminated display 1 accordingly.

The control includes the control of individual segments of the illuminated display 1. For example, various status signals, including complex ones, relating to the workstation, can be indicated by the illuminated display 1 via multicolor LEDs or flashing and/or running lights. It is advisable to implement the control unit 2 in such a way that it cannot be programmed via a computer according to the specific user requirements or that it generates, monitors and transfers the status displays to the control unit 2 via network devices such as switches, routers and servers and thus controls the illuminated display 1 accordingly.

In addition, a screen 9 is provided, for example that of the workstation computer, which displays the status displays and can also display further information.

In another special one, an acoustic output unit is provided, which subtly generates a perceptible noise and thus draws attention to a certain unfavorable condition. Instead of a noise, it is also possible to simply provide a vibration unit which, using suitable vibration patterns, points to conditions and generates attention.

By using a recognition unit which is connected to the respective workstation computer as office communication device 3, it is possible to log on and off to the respective applications or to the telephone system, for example via mobile terminals, for example via NFC or via transponders.

### LIST OF REFERENCE NUMERALS

1—Illuminated display
2—Interface, control unit
3—Office communication device, telephone
4—manual switching unit
5—sensory switching unit
6—Table top, desk top, office furniture, working table, desk
7—Connecting lines
8—Power supply unit, power adapter
9—Screen
10—Surface

1. Workstation status display system,
characterized in that
at least one illuminated display (1) and/or at least one screen (9) is arranged or integrated on or in an office furniture (6), whereby on the illuminated display(l) and/or on the screen, at least one interface (2) is available to at least one office communication device (3), a room equipment (3), an application and/or at least one manually or sensor-controlled switching unit (4, 5) or to at least one sensor, whereby the at least one illuminated display (1) and/or the at least one screen (9) is at least being designed to indicate the status with respect to an office workstation and/or office communication devices, applications, ambient conditions and/or employees.

2. Workstation status display system according to claim 1,
characterized in that
the illuminated display (1) is arranged or integrated in or on at least one outer edge of a table top (6), in or on the surface of a table top (6), in vertically aligned sections of a table structure and/or in an office furniture wall.

3. Workstation status display system according to claim 1,
characterized in that
the at least one screen is arranged or integrated on at least one outer edge of a table top (6), in or on the surface of a table top (6), in vertically aligned sections of a table structure and/or in an office furniture wall, or that the screen is the screen on a workstation computer.

4. Workstation status display system according to claim 1,
characterized in that
the screen is touch-sensitive and/or can be controlled or operated by gestures and/or comprises an input unit for adjusting the status with respect to the office workstation and/or to the office communication devices, applications, ambient conditions and/or to the employee.

5. Workstation status display system according to claim 1,
characterized in that
the illuminated display (1) is circular, band-shaped, segmented and/or designed to be individually controllable as a chaser light.

6. Workstation status display system according to claim 1,
characterized in that
the illuminated display (1) comprises at least one multicolor LED.

7. Workstation status display system according to claim 1,
characterized in that
the office communication device (3), for example, is a telephone, a computer, a printer, a scanner, a copier, a fax machine, a network device or a mobile terminal device.

8. Workstation status display system according to claim 1,
characterized in that
the sensor-controlled switching unit (5) is connected to an infrared sensor, a proximity sensor, a motion detector, a noise sensor, an energy consumption sensor, a temperature sensor, a gas sensor, a vital sensor, a gyro sensor and/or a closing contact.

9. Workstation status display system according to claim 1,
characterized in that
the at least one interface (2) is designed as a preferably programmable control unit (2) or in that the illuminated display (1), the screen (9) and/or the interface (2) interact with the control unit (2).

10. Workstation status display system according to claim 1,
characterized in that
an acoustic output unit and/or a vibration unit is connected to the workstation status display system.

11. Workstation status display system according to claim 1,
characterized in that
a user management application, an electronic reservation system and/or a recognition unit is connected to the workstation status display system.

12. Workstation status display system according to claim 1,
characterized in that
notes or information on the office communication devices and/or room equipment and/or on ambient conditions and/or on vital parameters can be displayed on the screen.
